(19) United States
(12) Patent Application Publication
(10) Pub. No.: US 2005/0160474 A1
(43) Pub. Date: Jul. 21, 2005

(54) Information processing device and program

(75) Inventors: Toshiro Obitsu, Kawasaki (JP); Hisamichi Higuchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/910,423

(22) Filed: Aug. 4, 2004

(30) Foreign Application Priority Data
Jan. 15, 2004 (JP) 2004-008544

(51) Int. Cl. H04N 7/173; G06F 13/00; H04N 5/445; G06F 3/00; G06F 15/177; G06F 9/445; G06F 9/24

(52) U.S. Cl. 725/132; 725/140; 725/152; 725/100; 725/51

(57) ABSTRACT

Receiving a boot instruction of the operating system, performing management by making a first recording area recognizable to the first operating system booted based on the boot instruction in an operating status of the first operating system stored in the first recording area, and making a second recording area unrecognizable that is stored with the second operating system.

### BACKGROUND OF THE INVENTION

The present invention relates to an information appliance having a television function.

Personal computers incorporating a television function have been put on the market and got available over the recent years. Consequently, users of the personal computers execute information processing on the personal computers or access the Internet via the personal computers on one hand, and can listen to and watch TV programs from on the personal computers on the other hand. The TV function becomes, however, utilizable by booting a television application after a normal OS (Operating System) has been booted.

The normal OS (hereinafter called a basic OS) must be booted in order to listen to and watch the television broadcasting on the conventional personal computers. For this reason, it is impossible to listen to and watch the television broadcasting unless the basic OS is normally booted. Further, a certain amount of time is required till it is possible to listen to and watch the television broadcasting after power-on of a power source.

Moreover, there was a device including a TV tuner provided in a monitor independently of the TV function of the personal computer. Pieces of information or images from the personal computer are displayed on this monitor of the device, while a received program of the television broadcasting signal can be displayed on the monitor directly from the TV tuner. Hence, there was no occurrence of the problem about whether the basic OS is normally booted or not, or whether the boot time is short or long.

This device, however, requires a TV tuner on the personal computer side in order to interface with a function of the personal computer and additionally requires another TV tuner on the monitor side. In this type of system, the television broadcasting can be displayed within a short period of time. But, this system requires two pieces of TV tuners, resulting in an increase in costs.

On the other hand, a known prior art is that a different OS for a dedicated function from the normal OS is prepared to make the device perform operations specialized in the dedicated function, and the OS to be booted is switched over according to the condition. (Example: Patent documents 1 and 2)

[Patent Document 1]

Japanese Patent Application Laid-Open Publication No.2002-132393

[Patent Document 2]

Japanese Patent Application Laid-Open Publication No.2002-288126

### SUMMARY OF THE INVENTION

Accordingly, the conventional system could not actualize the television display within a short period of time without any increase in costs.

Further, the prior art does not support any schemes for preventing the breakage of information of other OS, applications running on the OS and etc. while actualizing a short-time boot of the OS, when an OS is in exchange and run.

The invention aims at, in an information appliance installed with at least two operating systems, actualizing a technology of preventing the breakage of the information of the mutual operating systems. The invention further aims at, in an information appliance having a television function, actualizing a technology of booting the television function within a short period of time without increasing hardware.

For solving the problems, the invention adopts the following units. Namely, according to the invention, an information processing device on which a first operating system and a second operating system are operable, includes a receiving unit receiving a boot instruction of the operating system, and a controlling unit for performing management by making a first recording area recognizable to the first operating system booted according to the boot instruction while the first operating system stored in the first recording area is running, and making a second recording area storing the second operating system unrecognizable.

According to the invention, the management is conducted such that while the first operating system is running, the first recording area is set recognizable to the first operating system, and the second recording area storing the second operating system is set unrecognizable. Hence, there is a decreasing possibility that the second recording area storing the second operating system might be updated, broken and so forth due to the process running on the first operating system. Moreover, according to the invention, the television broadcasting signal receiving process can be booted simply and efficiently by preparing a specialized OS for the function suited to the receipt of the television broadcasting signal as the second operating system.

Preferably, the first recording area and the second recording area may be recognized by the operating system based on the first identifying information but not recognized based on the second identifying information, and the controlling unit may, when booting the second operating system according to the boot instruction, execute such setting that the first recording area is managed based on the second identifying information, and may include a booting unit for booting the second operating system.

According to the invention, the operating system is capable of recognizing the first recording area and the second recording area based on the first identifying information. The setting in the normal status is that the first recording area is managed based on the first identifying information, and the second recording area is managed based on the second identifying information. In this status, the operating system recognizes the first recording area but is unable to recognize the second recording area. It is therefore possible to reduce the possibility in which the second operating system and the information managed by the second operating system might be changed during the first operating system is running. On the other hand, when booting the second operating system, the setting is that the first recording area is managed based on the second identifying information. With this scheme, it is possible to reduce the possibility in which the first operating system and the information managed by the first operating system might be changed during the second operating system is running.

Preferably, the booting unit may boot the second operating system in a way that omits part of a process that should be run when the first operating system is booted. This is because the system may be built up by the specialization in, e.g., the function suited to the receipt of the television broadcasting signal, in booting the second operating system. Therefore, according to the invention, the second operating system can be booted within a short period of time.

Preferably, the booting unit may include a judging unit judging whether the second recording area recognized based on the second identifying information exists or not, and, if unable to recognize the existence of the second recording area, may boot the first operating system. Hence, according to the invention, the first operating system can be booted as usual in such a device that the second recording area is not provided.

The omitted process is, for example, a security check, etc. about resources or information managed by the operating system.

Further, the invention may be a method by which a computer or other device, machine, etc. executes any one of the aforesaid processes. Moreover, the invention may also be a program for making the computer or other device, machine, etc. actualize any one of the aforesaid processes. Still further, the invention may take a form that such a program is stored on a recording medium readable by the computer, etc.

According to the invention, in an information appliance with at least two types of operating systems installed, the breakage of the information of the mutual operating systems can be prevented. Further, the actualization of preventing the information breakage enables an omission of a variety of check processes for the operating system and the actualization of booting the operating system within a short period of time.

Moreover, according to the invention, in an information appliance having a television function, the television function can be booted within a short period of time without increasing hardware.

### DESCRIPTION OF THE DRAWINGS

FIG. 1 is a view of a configuration of an information processing device according to a best mode of the invention;

FIG. 2 is a view of a configuration of a remote controller 2;

FIG. 3 is a hardware block diagram of an information processing device body; and

FIG. 4 is a flowchart showing a process at power-on of the information processing device.

### DETAILED DESCRIPTION OF THE INVENTION

An information processing device according to a best mode (hereinafter called an embodiment) for carrying out the invention, will be described below with reference to the drawings. A configuration of the following embodiment is just an exemplification, and the invention is not limited to the configuration of the following embodiment.

<Outline of Functions>

Two pieces of software, i.e., a normal basic OS and a dedicated OS are pre-installed in this information processing device. This dedicated OS has a simplified function specialized in receiving television broadcasting signal and is therefore called a simple OS. A period of time till a television function is started up, is reduced by booting this dedicated OS in a short time.

Further, a normal type of information device such as a personal computer, etc. has only one button of a power source. By contrast, the present information processing device is prepared with a button (which is called a dedicated function button) different from the normal power button in order to boot the dedicated OS.

BIOS (Basic Input/Output System) (which corresponds to a receiving unit, a control unit and a booting unit) built in the information processing device, distinguishes between an operation via the power button and an operation via the dedicated function button. Then, the BIOS boots the basic OS upon the input of the power button. On the other hand, the BIOS boots the dedicated OS upon the input of the dedicated function button.

This being thus done, the basic OS and the dedicated OS are previously stored in different segmented areas (hereinafter called partitions). Then, the BIOS is set so that the OS's are respectively booted from its own partition, depending on which button, the power button or the dedicated function button, the input is given from. This mechanism enables the dedicated OS to be booted upon the input of the dedicated function button.

Further, the embodiment aims at booting the dedicated OS within a short time, and therefore information is stored in a hibernate status. Namely, a memory image is stored on a hard disk in an as executed status of plural processes (tasks) configuring an operation of the dedicated OS. Such a memory image will hereinafter be referred to as a hibernate image.

Therefore, applications and other pieces of information, which are used for process of the other dedicated OS and the dedicated OS during the basic OS is running, must be prevented from being rewritten. Such being the case, a scheme of the information processing device is that the partition stored with the dedicated OS is set unrecognizable from the basic OS during the execution of the basic OS. This mechanism makes the dedicated OS partition unrecognizable from the basic OS and from a program running on the basic OS even if the basic OS is booted, and it never happens that the information in the dedicated. OS partition is rewritten. This scheme enables the hibernate image to be retained and the dedicated OS to be booted within a short time.

The partition stored with the dedicated OS has an ID of this partition (hereinafter called a partition ID), that is different from ID of a normal partition, therefore the partition is not accessed when remaining unchanged. Accordingly, normally, the dedicated OS can not be booted. Further, a capacity for the disk image can be reduced because of installing none of such a driver, and a period of processing time expended for restoring the disk image back to a memory can be reduced.

According to the information system, a driver program (e.g., disk.sys) of the hard disk is changed. Namely, the information processing device recognizes whether the input is the power button input or the dedicated function button input, and reads the partition ID based on the input, on a driver level. With this scheme, the BIOS boots the OS in each partition, according to the power button input or the dedicated function button input.

Moreover, a mouse, a keyboard, LAN and MODEM are set incapable of functioning in driver during the dedicated OS is running on the information processing device. This setting makes a user unable to change the data within the information processing device during the dedicated OS is running.

Disk.sys exemplified above is categorized as a driver for controlling an IDE (Integrated Drive Electronics) interface. According to the information processing device, the partition ID is converted within the driver by use of the IDE driver. In the information processing device, a partition ID of the normal partition is set to 07h (partition ID=07h). The basic OS and the driver program on the information processing device, recognize the partition assigned 07h (partition ID=07h) as a legitimate partition, and input and output data to the recognizable partition.

On the other hand, a partition ID of the dedicated OS partition stored with a television receiving application (corresponding to a unit controlling receiving conditions) is set to 12h (partition ID=12h). The partition ID “12h” is not normally used on the basic OS, and hence the partition assigned 12h is, as viewed from the normally-booted basic OS, recognized as an unknown partition. It is therefore impossible to access the partition stored with the television receiving application while the basic OS is running. Hence, it does not happen that the dedicated OS is broken during the normal basic OS is running.

Further, when the dedicated OS is booted, the driver program reads the partition (partition ID=07h) of the normal basic OS so as to be exchanged for 12h. With this scheme, conversely when the dedicated OS is running, the area stored with the normal basic OS is recognized as an unknown area. Thus, the basic OS and the dedicated OS are stored completely independently of each other, and run separately. Accordingly, there is no occurrence of such a problem that the other OS is carelessly broken, or the security can not be maintained during one OS is running, due to the process during the other OS is running.

<Device Configuration>

The information processing device can be actualized as an information device exemplified by a personal computer, a PDA (Personal Digital Assistant), a cellular phone and so on. The following discussion shows an example of actualizing the information processing device by way of a personal computer.

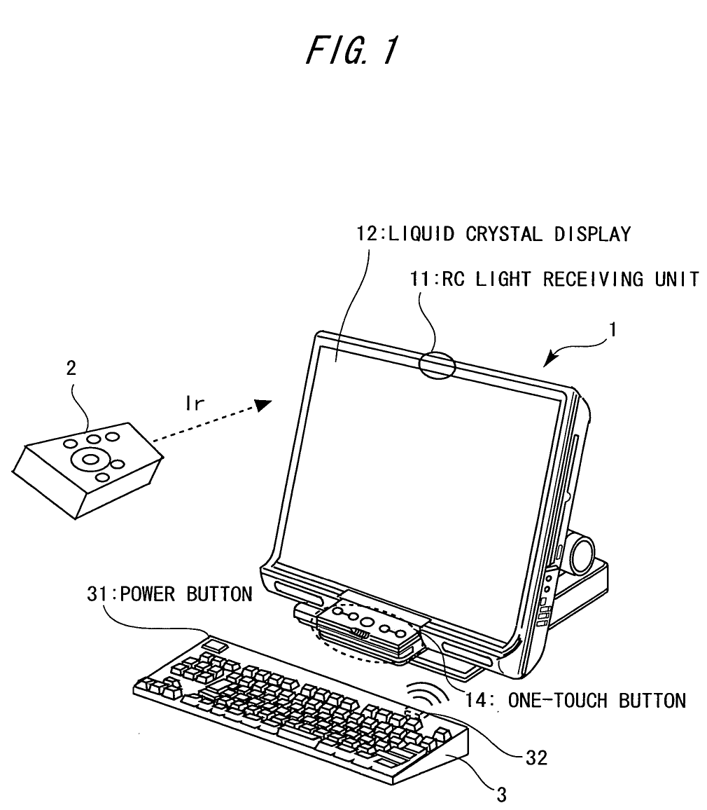

FIG. 1 is a view showing a configuration of the information processing device. The information processing device includes a device body 1, a remote controller 2 (hereinafter be abbreviated to “RC 2” as the case may be) for controlling the device body 1, a keyboard 3 interfaced with the device body 1, and an unillustrated mouse.

The device body 1 has a liquid crystal display 12, a screen chassis embracing a periphery of the liquid crystal display 12, a RC light receiving unit 11 provided on an upper portion of the screen chassis, and a one-touch button 14 provided on a front side of the screen chassis and at a lower central portion of the liquid crystal display 12. Further, a CPU for providing functions of the information processing device, a memory (including a RAM and a ROM), a hard disk, a TV tuner and a variety of controllers are built in the device body 1.

The RC light receiving unit 11 receives infrared-ray signals from the remote controller 2 and transmits the signals to the devices within the device body 1. The RC light receiving unit 11 is a so-called Ir (Infrared) device.

In the information processing device, the keyboard 3 and the unillustrated mouse are linked via wireless signals to the device body 1. The keyboard 3 and the mouse are so-called wireless keyboard and wireless mouse. The embodiment of the invention is not, however, limited to the information processing device having this type of wireless keyboard and wireless mouse. The invention can be applied to an information processing device having a wired keyboard and a wired mouse that are connected via cables.

As shown in FIG. 1, the keyboard 3 includes a wireless interface module 32 and a power button 31. Pressing state of respective keys on the keyboard 3 and the power button 31, are transmitted via the wireless interface module 32 to the device body 1. Note that the power button 31 is provided on the keyboard 3 but is not under the control of the keyboard driver, because of the power button 31 is controlled by differently from the respective keys. Hence, the device body 1 (BIOS) can recognize that the power button 31 is pressed even when the keyboard driver is not installed for a booting status of the dedicated OS. Moreover, the wireless interface module 32 is not limited to a specific architecture in the embodiment of the invention.

The wireless interface module 32 may utilize any kinds of wireless signals such as the infrared-rays, electromagnetic waves, sound waves, etc. When the wireless interface module 32 uses the infrared-rays, the RC light receiving unit 11 may also be made to receive the infrared-rays. When the wireless interface module 32 uses electromagnetic waves, there is no limit to application of the communications standards. For example, the communications based on Bluetooth standards, other communications standards as used for wireless LAN, etc. and using independent communication procedures are also available. Note that the power button 31 (corresponding to a first detecting unit detecting a first user's operation) of the keyboard 3 in the information processing device is employed for booting the so-called basic OS.

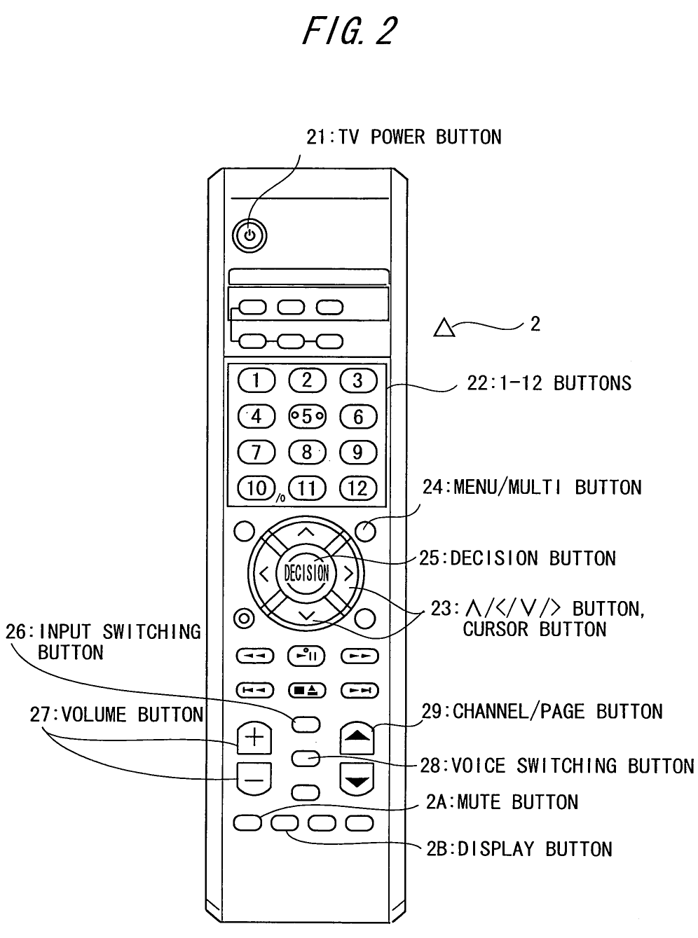

FIG. 2 is a view showing a configuration of the remote controller 2. The remote controller 2 has a TV power button 21, 1-12 buttons 22, cursor buttons 23, menu/multi buttons 24, a decision button 25, an input switchover button 26, sound volume buttons 27, a voice switchover button 28, channel/page buttons 29, a mute button 2A, a display button 2B and an unillustrated light emitting unit.

Among these components, the TV power button 21 (corresponding to a dedicated function button and a second detecting unit detecting a second user's operation) is employed for booting the dedicated OS for simply receiving the television broadcasting signal. Namely, when the TV power button 21 is pressed during power off of the information processing device, and if predetermined boot conditions are set, the dedicated OS and an application for receiving the television broadcasting signal are booted. The dedicated OS enables a user to listen to and watch the television broadcasting in a shorter period of time than in the case of booting the basic OS.

The 1-12 buttons 22 is used for selecting TV channels 1 through 12. According to the embodiment of the invention, however, the number of selectable channels and the selectable channel numbers are not limited to the range of 1 through 12, and may properly changed according to a state of the television broadcasting. Moreover, channel numbers exceeding “12” may also be selectable by combining the buttons “1” through “12”.

The cursor buttons 23 are used for selecting menu items on the application for receiving the television broadcasting signal or on other application of the information processing device. The cursor buttons 23 are employed when moving the cursor on, e.g., a menu screen for selecting the menu items.

When the menu/multi buttons 24 are pressed, the information processing device displays menus on the screen. Further, the decision button 25 is used for deciding an option on the menu. The input switchover button 26 is employed for switching over an input destination of video signals displayed during an execution of the television broadcast receiving application. In the example of the information processing device, every time the input switchover button 26 is pressed, the input destination of the video signals is switched over in the sequence of a TV tuner, a video input terminal and an S-video (Separate Video) signal terminal.

The sound volume button 27s are used for an output adjustment of the sound volume of the television broadcasting signal received. The mute button 2A is employed for an ON/OFF switchover of the sound volume output of the television broadcasting signal received. Further, the display button 2B is used for switching over display of receiving states (the receiving channel, the sound volume, etc.) of the present television broadcasting signal on the screen.

Note that the remote controller 2 includes an unillustrated infrared-ray emitting unit and transmits the pressing state of each of the buttons as discussed above, to the device body 1. The emission and the receipt of the infrared-rays are broadly known, and hence their explanations are omitted.

<Hardware Architecture>

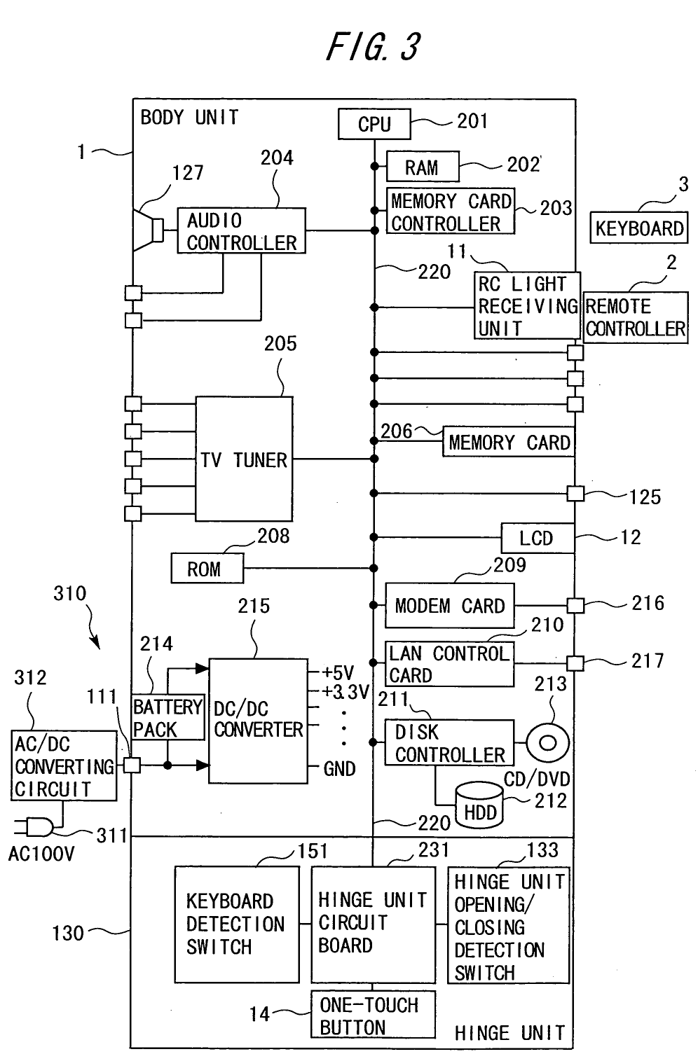

FIG. 3 shows a hardware block diagram of the device body 1. The device body 1 includes a CPU 201 for controlling the information processing device, a RAM 202 for storing programs executed on the CPU 201 or data processed by the CPU 201, a memory card controller 203 for controlling an access to a memory card, an audio controller 204 for acoustic outputs (voices and sounds), a speaker 127 for audibly outputting the outputs of the audio controller 204, a RC light receiving unit 11 for receiving the infrared-ray signals from the remote controller 2, a TV tuner 205 for receiving the television broadcasting signal, a memory card slot 206 through which the memory card is inserted, a liquid crystal display 12 for displaying information (pictures, character information, etc.) of the television broadcasting signal received by the TV tuner 205 or displaying information processed by the CPU 201, a rewritable ROM 208 for storing the BIOS, a MODEM card 209 for accessing an external network via a telephone line, a LAN control card 210 for accessing the LAN, a power source unit 310 (including an AC/DC converting circuit 312, a battery pack 214 and a DC/DC converter 215), a hard disk drive unit 212, a CD/DVD drive unit 213, and a disk controller 211 for controlling respective drive units of the hard disk and the CD/DVD.

Moreover, the device body 1 is connected through a hinge member to a hinge unit 130. The hinge unit 130 has a keyboard detection circuit 151 for detecting the signals from the keyboard 3, a hinge unit opening/closing detection switch 133 for detecting opening/closing states of the hinge unit, a hinge unit circuit board 231, and a variety of one-touch buttons 14 provided on the front side of the device body 1.

The TV tuner 205 selects and receives a channel indicated by the television receiving application executed on the CPU 201. Pictures of the channel received are outputted via an unillustrated graphics unit to the liquid crystal display 12. Further, sounds of the channel received are processed by the audio controller 204 and thus outputted from the speaker 127.

The infrared-ray signals from the remote controller 2 are received by the RC light receiving unit 11 and transmitted to the CPU 201 through an unillustrated chip set. The wireless signals from the keyboard 3 are likewise received by an unillustrated wireless signal receiving unit and transmitted via an unillustrated chip set to the CPU 201. As described earlier, however, in the case of the device using the infrared-ray signals as the wireless signals from the keyboard 3, the RC light receiving unit 11 may receive the wireless signals.

The hard disk driven by the hard disk drive unit 212 has a plurality of segmented areas (which may also be called partitions, logical drives, logical units or logical devices, etc.). Among these partitions, the partition stored with the normal OS is assigned 07h as a partition ID (partition ID=07h) and is recognized as the partition to which the normal OS and the driver program have an access. On the other hand, the partition stored with the TV receiving dedicated OS is assigned 12h as a partition ID (partition ID=12h).

<Setting of OS Boot Conditions>

The information processing device is capable of performing valid/invalid setting of the dedicated OS (TV function) boot through a user interface operation by user (BIOS setup) provided by the BIOS.

(1) Case of Setting the Dedicated OS Boot Valid by BIOS

(1-1) When Information Processing Device Is in Shutdown Status (OFF-State of Power Source);

In this case, when detecting that the TV power button 21 of the remote controller 2 has been pressed, the BIOS boots the dedicated OS. On the other hand, when detecting that power button 31 provided on the keyboard 3 has been pressed, the BIOS boots the normal basic OS.

(1-2) When Information Processing Device Is in the Status That Dedicated OS Is Running;

In this case, when detecting that the TV power button 21 of the remote controller 2 has been pressed, the BIOS terminates the dedicated OS. Further, when detecting that power button 31 provided on the keyboard 3 has been pressed, the BIOS also terminates the dedicated OS. Namely, during the dedicated OS is running (during the television broadcasting signal receiving application is running), even when any one of the TV power button 21 and the power button 31 provided on the keyboard 3 is pressed, the information processing device terminates the television receiving function.

(1-3) When Information Processing Device Is in the Status That Basic OS Is Running;

In this case, when detecting that the TV power button 21 of the remote controller 2 has been pressed, the BIOS invalidates this pressing. Namely, the BIOS makes no reaction. This scheme prevents the power source of the information processing device body from being carelessly switched OFF by the remote controller 2.

On the other hand, when detecting that the power button 31 on the keyboard 3 has been pressed, the BIOS executes a process depending on the setting (which is the setting of the power source option) of the normal basic OS. For example, the termination of the basic OS (the power source OFF) or a shift to the standby status can be selected as the power source option.

(2) Case of Setting Boot of Dedicated OS Invalid

(2-1) When Information Processing Device Is in Shutdown Status (Power Source OFF Status);

In this case, when detecting that any one of the TV power button 21 of the remote controller 2 and the power button 31 on the keyboard 3 has been pressed, the BIOS boots the basic OS.

(2-2) When Information Processing Device Is in the Status That Basic OS Is Running;

In this case, when detecting that any one of the TV power button 21 of the remote controller 2 and the power button 31 on the keyboard 3 has been pressed, the BIOS executes a process depending on the setting of the normal basic OS (which is the setting of a power source option). The power source option is exemplified such as the termination of the basic OS (the power source OFF) or the shift to the standby status.

<Processing Flow>

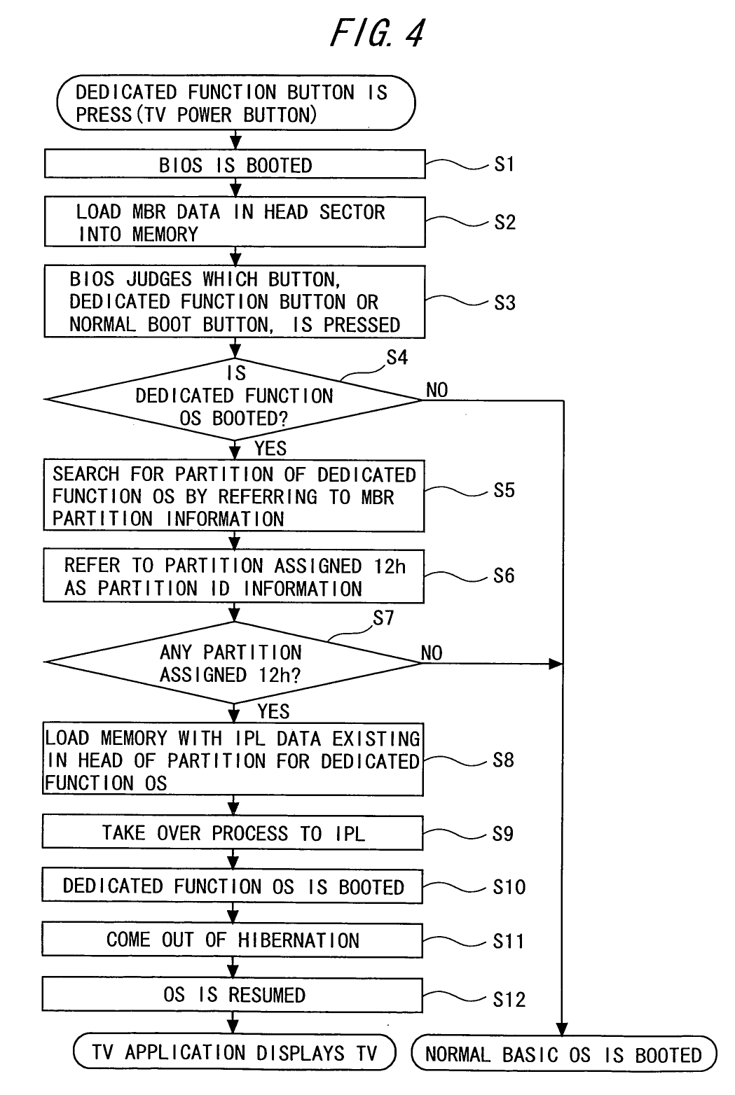

FIG. 4 shows a process at power-on of the power source of the information processing device. This process is a process in a state where the boot of the dedicated OS is set valid through the user interface provided by the BIOS, and the power source is switched OFF by this setting. Moreover, in an initial status, the partition ID of the hard disk partition stored with the basic OS is set to 07h, while the partition ID of the partition stored with the dedicated OS is set to 12h.

This process is booted by pressing the TV power button 21 of the remote controller 2 (or the power button 31 on the keyboard 3). In this process, to start with, the BIOS stored on the ROM 208 is booted (S1). Then, the BIOS loads a master boot record (MBR) stored in a head sector of the hard disk into the memory (the RAM 202) (S2).

Next, the BIOS judges whether the pressed button is the TV power button 21 (which is also simply called a dedicated function button) for booting the dedicated OS or the power button 31 (which is also simply called a normal boot button) for booting the normal basic OS (S3). Then, when judging that the TV power button 21 is not pressed (NO in S4), the BIOS shifts the control to the partition assigned 07h as the partition ID in accordance with the normal procedures. The normal basic OS is thereby booted (wherein the CPU 201 executing the BIOS corresponds to a receiving unit and a booting unit).

On the other hand, if the judgment in S4 is that the TV power button 21 has been pressed, the BIOS searches for the partition of the dedicated OS by referring to the partition information in the master boot record (S5). Namely, the BIOS searches for the partition assigned 12h as the partition ID (S6).

As a result, if none of the partitions assigned 12h as the partition ID are discovered (No in S7), the BIOS shifts the control to the partition assigned the partition ID “07h” in accordance with the normal procedures. The normal basic OS is thereby booted.

Whereas if the judgment in S7 is that the partition assigned the partition ID “12h” is discovered, the BIOS shifts the control to this partition (of which the partition ID is 12h). Then, the BIOS loads IPL (Initial Program Loader) data existing in the head of the partition into the memory (S8).

Subsequently, the BIOS takes over the process to the IPL (S9). To be more specific, the control of the CPU 201 is taken over to the IPL. The dedicated OS stored in this partition is thereby booted. The dedicated OS has been stored as the memory image in the hibernate status on the hard disk, and is therefore restored as it remains unchanged into the memory (the RAM 202). Then, the dedicated OS is recovered (S12), and the television receiving application is booted.

Hereafter, the information processing device, under the control of the television receiving application, indicates a receiving channel to the TV tuner 205, and makes the TV tuner 205 to receive the television broadcasting signal of the channel selected by the user. Moreover, the information processing device, under the control of the television receiving application, indicates a sound volume of the receiving channel to the audio controller 204. Such a television broadcasting signal receiving process by the television receiving application has already been broadly known, and hence its explanation is omitted.

In a subsequent process during the execution of the dedicated OS, the access to the hard disk is executed by the dedicated driver program. The driver program reads the partition ID “12h” (ID=12h) as 07h (ID=07h). Further, the driver program processes the partition assigned the partition ID “07h” (ID=07h) as the partition assigned the partition ID “12h” (ID=12h). Accordingly, in the subsequent process, the partition having the partition ID “12h” (ID=12h) is recognized, and it follows that the partition having the partition ID “07h” (ID=07h) exists as an unknown partition that is recognizable but inaccessible by the driver (wherein the CPU 201 executing the driver program used by the basic OS and the dedicated driver program, corresponds to a controlling unit).

Moreover, the dedicated OS provides such setting that the mouse, the keyboard, the LAN and the MODEM, which are utilized based on the normal basic OS, do not function on the driver-by-driver basis (namely, the drivers that support these devices and the LAN networking are so installed as to function when the basic OS is running). Accordingly, there is no necessity of checking these pieces of hardware. Further, this scheme makes the user unable to change the data within the information processing device, during the dedicated OS is running. It is therefore unnecessary to execute security checks of resources and data managed by the dedicated OS. It is checked during the basic OS is running whether a password and a variety of set values of the BIOS are changed or not, and so forth. The dedicated OS does not, however, necessitate these checks. Accordingly, the dedicated OS can be booted within a short period of time.

As discussed above, according to the information processing device, the television receiving application is installed into the dedicated OS, whereby the setting of the dedicated OS is just for executing the driver for listening to and watching the television broadcasting or for the display thereof. Hence, the dedicated OS can be booted within a short period of time. Moreover, the boot of the dedicated OS is the process of restoring from the hibernate status, and the process requiring a much shorter period of time can be actualized.

Then, this boot is executed by the simple operation via the dedicated button named the TV power button 21. The dedicated OS can be thereby simply booted within a short period of time without burdening the user with any task, and as a result a preparation for listening to and watching the television broadcasting is made within a short period of time. In this case, as compared with a system implementing a second piece of TV tuner on the monitor side with no intermediary of the OS, the cost can be reduced down and the system can be simplified because of utilizing only the single TV tuner. As a consequence, a space for implementing the components can be reduced. Further, the dedicated OS is configured in a way that deletes unnecessary components out of the functions of the original basic OS, and can therefore simply attain its extended functions.

Moreover, in the information processing device explained in the embodiment, the basic OS and the dedicated OS are stored in the different partitions identified with the different partition IDs. Hence, the partition stored with the dedicated OS is unrecognizable to the basic OS in the basic OS execution status. The dedicated OS in the hibernate status can be therefore retained in safety. Moreover, the partition stored with the basic OS is unrecognizable to the dedicated OS in the dedicated OS execution status. It is not therefore required to take into consideration a write-access to the resources or the information of the information processing device through the user's operation during the dedicated OS is running, whereby the security checks can be simplified.

<Modified Examples>

The embodiment has exemplified the information processing device in which the dedicated OS partition recognized by the partition ID “12h” (partition ID=12h) is stored with the television receiving application. The embodiment of the invention is not, however, limited to this scheme. For instance, the television receiving application may also be stored in both of the partition stored with the dedicated OS and the partition stored with the basic OS.

The embodiment has exemplified the use of the power button 21 of the remote controller 2 when booting the dedicated OS for receiving the television broadcasting signal. The embodiment of the invention is not, however, limited to this scheme. For example, the chassis of the device body 1 may be provided with a button for booting the dedicated OS for receiving the television broadcasting signal. Further, the mouse may also be provided with the button for booting the dedicated OS for receiving the television broadcasting signal. Moreover, the button for booting the dedicated OS for receiving the television broadcasting signal may also be provided on the keyboard 3 separately from the power button 31.

According to the embodiment, Disk.sys defined as the driver for controlling the IDE interface reads one partition ID of the partition in exchange for the other, thereby booting the basic OS and the dedicated OS in distinction. The invention is not, however, confined to the storage device using the IDE interface and can be carried out in the same procedures as the above-mentioned even in the case of booting the OS from on storage devices using other types of interfaces.

Namely, the invention can be carried out by providing two pieces of boot buttons on condition that the system has the function of distinguishing between the recognizable partition and the unrecognizable partition, the function of replacing the recognizable partition and the unrecognizable partition with each other, and the function of booting the OS from the partition that could be recognized.

Moreover, another possible scheme according to the invention is not that, as described above, the recognizable partition and the unrecognizable partition are replaced with each other but that information for making unrecognizable the partition stored with the other OS is simply set through the boot target OS.

<Readable-by-Computer Recording Medium>

A program for making a computer actualize any one of the functions can be recorded on a readable-by-computer recording medium. Then, the computer reads and executes the program on this recording medium, thereby enabling the function thereof to be provided.

Herein, the readable-by-computer recording medium connotes a recording medium capable of storing information such as data, programs, etc. electrically, magnetically, optically and mechanically or by chemical action, which can be read by the computer. Among those recording mediums, the mediums demountable out of the computer are, e.g., a flexible disk, a magneto-optic disk, a CD-ROM, a CD-R/W, a DVD, a DAT, an 8 mm tape, a memory card, etc.

Further, a hard disk, a ROM (Read Only Memory) and so on are classified as recording mediums fixed within the computer.

1. An information processing device comprising:
a controlling unit controlling conditions for receiving television broadcasting signal through an operating system;
a receiving unit receiving the television broadcasting signal in accordance with the receiving condition;
a first detecting unit detecting a first user's operation;
a second detecting unit detecting a second user's operation; and
a booting unit booting a first operating system for providing an information processing function according to the first user's operation, and booting a second operating system for providing a function of receiving the television broadcasting signal according to the second user's operation.

2. An information processing device according to claim 1, further comprising recording unit storing said first operating system in a first recording area recognized based on first identifying information, and storing said second operating system in a second recording area recognized based on second identifying information but unrecognizable based on the first identifying information,
wherein said booting unit reads said first operating system from said first recording area recognized based on the first identifying information according to the first user's operation, and reads said second operating system from said second recording area in a way that replaces the first identifying information and the second identifying information with each other, according to the second user's operation.

3. An information processing device according to claim 1, wherein said booting unit boots said second operating system in a way that omits part of a booting process of said first operating system.

4. An information processing device according to claim 2, wherein said booting unit judges whether the second recording area recognized based on the second identifying information exists or not, and boots said first operating system, if unable to recognize the existence of the second recording area.

5. An information processing device according to claim 3, wherein the omitted process is a security check about resources or information managed by said operating system.

6. A computer program for making a computer receives television broadcasting signal, the computer program comprising the step of:
detecting a first user's operation or a second user's operation;
booting a first operating system for providing an information processing function according to the first user's operation;
booting a second operating system for providing a function of receiving the television broadcasting signal according to the second user's operation; and
controlling conditions for receiving television broadcasting signal via said first operating system or said second operating system, and thus receiving the television broadcasting signal.

7. A computer program according to claim 6, wherein said computer is connected to recording unit including a first recording area recognized based on first identifying information and a second recording area recognized based on second identifying information but unrecognizable based on the first identifying information, said first recording area is stored with said first operating system, while said recording area is stored with said second operating system, and
said step of booting includes the step of, reading said first operating system from said first recording area recognized based on the first identifying information according to the first user's operation, and reading said second operating system from said second recording area in a way that replaces the first identifying information and the second identifying information with each other, according to the second user's operation.

8. A computer program according to claim 6, wherein said step of booting involves booting said second operating system in a way that omits part of a booting process of said first operating system.

9. A computer program according to claim 7, wherein said step of booting includes the step of, judging whether the second recording area recognized based on the second identifying information exists or not, and booting said first operating system, if unable to recognize the existence of the second recording area.

10. A computer program according to claim 8, wherein the omitted process is a security check about resources or information managed by said operating system.

11. A television broadcasting signal receiving method comprising:
detecting a first user's operation or a second user's operation;
booting a first operating system for providing an information processing function according to the first user's operation, and booting a second operating system for providing a television broadcasting signal receiving function according to the second user's operation; and
controlling conditions for receiving television broadcasting signal via said first operating system or said second operating system, and thus receiving the television broadcasting signal.

12. A television broadcasting signal receiving method according to claim 11, wherein a first recording area recognized based on first identifying information is stored with said first operating system, and a second recording area recognized based on second identifying information but unrecognizable based on the first identifying information is stored with said second operating system, and
when booting, reading said first operating system from said first recording area recognized based on the first identifying information according to the first user's operation, and reading said second operating system from said second recording area in a way that replaces the first identifying information and the second identifying information with each other, according to the second user's operation.

13. A television broadcasting signal receiving method according to claim 11, when booting, booting said second operating system in a way that omits part of a booting process of said first operating system.

14. A television broadcasting signal receiving method according to claim 12, when booting, judging whether the second recording area recognized based on the second identifying information exists or not, and booting said first operating system, if unable to recognize the existence of the second recording area.

15. A television broadcasting signal receiving method according to claim 13, wherein the omitted process is a security check about resources or information managed by said operating system.

16. An information processing device on which a first operating system and a second operating system are operable, comprising:
a receiving unit receiving a boot instruction of said operating system; and
a controlling unit performing management by making a first recording area recognizable to said first operating system booted according to the boot instruction while said first operating system stored in said first recording area is running, and making a second recording area storing the second operating system unrecognizable.

17. An information processing device according to claim 16, wherein said first recording area and said second recording area are recognized by said operating system based on first identifying information but not recognized based on second identifying information, and
wherein said controlling unit executes such setting that the first recording area is managed based on the second identifying information, and boots said second operating system, when booting said second operating system according to the boot instruction.

18. An information processing device according to claim 17, wherein said booting unit boots said second operating system in a way that omits part of a booting process of said first operating system.

19. An information processing device according to claim 17, wherein said booting unit judges whether the second recording area recognized based on the second identifying information exists or not, and boots said first operating system, if unable to recognize the existence of the second recording area.

20. An information processing device according to claim 18, wherein the omitted process is a security check about resources or information managed by said operating system.

21. A computer program running on a computer on which a first operating system and a second operating system are operable, the computer program comprising the step of:
receiving a boot instruction of said operating system; and
controlling for performing management by making a first recording area recognizable to said first operating system booted according to the boot instruction while said first operating system stored in said first recording area is running, and making a second recording area storing the second operating system unrecognizable.

22. A computer program according to claim 21, wherein said first recording area and said second recording area are recognized by said operating system based on first identifying information but not recognized based on second identifying information, and
wherein said step of controlling makes said computer execute instructions for booting as above, when booting said second operating system according to the boot instruction, booting said second operating system by executing such setting that the first recording area is managed based on the second identifying information.

23. A computer program according to claim 22, wherein said step of booting involves booting said second operating system in a way that omits part of a booting process of said first operating system.

24. A computer program according to claim 22, wherein said step of booting includes the step of, judging whether the second recording area recognized based on the second identifying information exists or not, and booting said first operating system, if unable to recognize the existence of the second recording area.

25. A computer program according to claim 23, wherein the omitted process is a security check about resources or information managed by said operating system.

26. A control method of an information processing device on which a first operating system and a second operating system are operable, comprising:
receiving a boot instruction of said operating system; and
controlling for performing management by making a first recording area recognizable to said first operating system booted according to the boot instruction while said first operating system stored in said first recording area is running, and making a second recording area storing the second operating system unrecognizable.

27. A control method according to claim 26, wherein said first recording area and said second recording area are recognized by said operating system based on first identifying information but not recognized based on second identifying information, and
in controlling, booting said second operating system by executing such setting that the first recording area is managed based on the second identifying information, when booting said second operating system according to the boot instruction.

28. A control method according to claim 27, when booting, booting said second operating system in a way that omits part of a booting process of said first operating system.

29. A control method according to claim 27, when booting, judging whether the second recording area recognized based on the second identifying information exists or not, and booting said first operating system, if unable to recognize the existence of the second recording area.

30. A control method according to claim 28, wherein the omitted process is a security check about resources or information managed by said operating system.
